(19) United States
(12) Patent Application Publication
(10) Pub. No.: US 2026/0273656 A1
(43) Pub. Date: Sep. 17, 2026

(54) LASER WELDING APPARATUS AND LASER WELDING METHOD

(71) Applicant: Kabushiki Kaisha Toshiba, Kawasaki-shi (JP)

(72) Inventor: Tetsuo SAKAI, Taito Tokyo (JP)

(21) Appl. No.: 19/543,819

(22) Filed: Feb. 18, 2026

(30) Foreign Application Priority Data
Mar. 12, 2025 (JP) 2025-039782

(51) Int. Cl. B23K 26/064; B23K 26/21

(52) U.S. Cl. CPC B23K 26/0652; B23K 26/0648; B23K 26/21

(57) ABSTRACT

A laser welding apparatus includes a laser beam source configured to emit a laser beam, a first lens configured to convert the laser beam into a parallel laser beam, a second lens configured to focus the laser beam on a processing target, and an optical element that is provided in an optical path between the first lens and the second lens and configured to change a beam profile of the laser beam.

### CROSS-REFERENCE TO RELATED APPLICATION(S)

This application is based upon and claims the benefit of priority from Japanese Patent Application No. 2025-039782, filed Mar. 12, 2025, the entire contents of which are incorporated herein by reference.

### FIELD

Embodiments described herein relate generally to a laser welding apparatus and a laser welding method.

### BACKGROUND

A laser welding apparatus is an apparatus that welds a processing target using a laser beam. The laser beam emitted from a laser oscillator is irradiated on the processing target through an optical system including a condensing lens. The processing target is intensely irradiated with the laser beam, so that a processing point and the vicinity thereof can be melted. As a result, unnecessary temperature rise in a portion other than the processing point is reduced, and thus, it is possible to perform local and rapid processing with reduced distortion due to heat as compared with other welding methods such as arc welding. By welding along a trajectory intended for scanning of the laser beam during processing, it is also possible to process a complicated shape such as a curve or a pattern.

However, in the above method, the metal vapor generated from the processing target may interfere with a keyhole, which is a deep cavity formed during laser irradiation, depending on the processing conditions. As a result, a part of the molten metal scatters, and spatter that adheres to the surface of the processing target is likely to occur. This spatter deteriorates the quality of welding and increases the amount of work required for post-processing.

A method of adjusting a beam profile including information such as a beam diameter and an intensity distribution of the laser beam in order to reduce the generation of the spatter is known. In this method, the laser beam is formed by combining a main beam having high intensity and a sub-beam having relatively low intensity, and is irradiated on the processing target placed at the focal point. In a region to be irradiated with the sub-beam, the processing target is preheated, and thereafter, a keyhole (deep depression) is generated by the main beam in the molten pool region. The size of the keyhole is expanded due to the influence of the additional heat quantity of the sub-beam, and the probability of interference with the metal vapor is reduced, so that the generation of the spatter from the molten pool can be reduced, and the quality deterioration due to the processing defect can be prevented.

In order to achieve processing for performing such a beam profile, a laser welding apparatus having an excellent configuration for controlling the power distribution of the beam profile at the processing point is devised in the related art. However, in the configuration in the related art, the number of optical elements is increased, the cost is high, and the occupied volume required for the entire apparatus is also increased, so that it is difficult to retrofit the existing apparatus.

### BRIEF DESCRIPTION OF THE DRAWINGS

FIG. 1 is a conceptual schematic diagram of a laser welding apparatus according to a first embodiment.

FIG. 2 illustrates a beam-shaping optical element according to the first embodiment in two different views.

FIG. 3 shows an intensity distribution of an irradiation light beam according to the first embodiment.

FIG. 4 illustrates a beam-shaping optical element according to a second embodiment in two different views.

FIG. 5 shows an intensity distribution of an irradiation light beam according to the second embodiment.

FIG. 6 illustrates a beam-shaping optical element according to a third embodiment in two different views.

FIG. 7 shows an intensity distribution of an irradiation light beam according to the third embodiment.

FIG. 8 is a conceptual schematic diagram of an intermediate optical system according to an embodiment.

### DETAILED DESCRIPTION

Embodiments provide a laser welding apparatus capable of forming a beam profile with a single optical element and performing high-precision laser welding while reducing the generation of spatter.

In general, according to one embodiment, a laser welding apparatus includes a laser beam source configured to emit a laser beam, a first lens configured to convert the laser beam into a parallel laser beam, a second lens configured to focus the laser beam on a processing target, and an optical element that is provided in an optical path between the first lens and the second lens and configured to change a beam profile of the laser beam.

Hereinafter, embodiments will be described with reference to the drawings. In each drawing, the same elements are denoted by the same reference numerals, and redundant descriptions thereof are omitted.

### First Embodiment

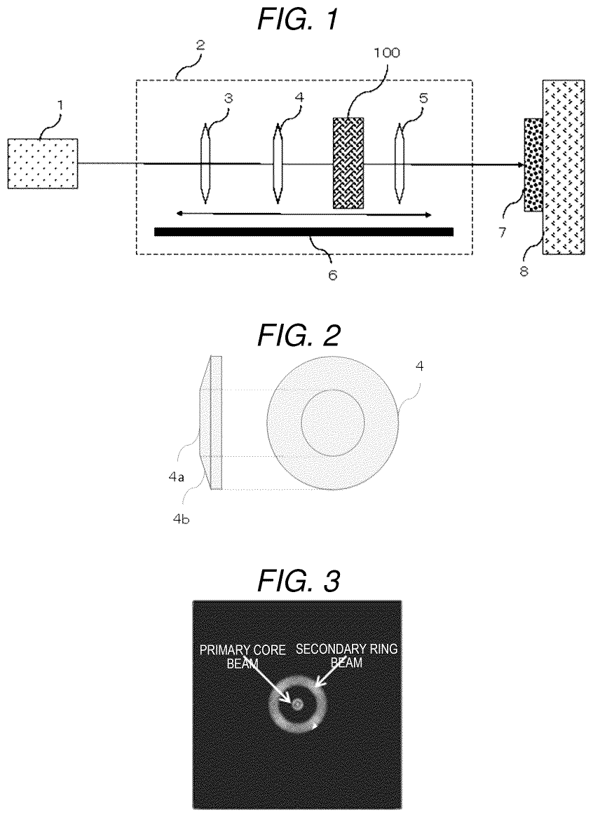

FIG. 1 is a schematic two-dimensional plane view of an overall configuration of a laser welding apparatus according to a first embodiment. As shown in the drawing, an optical system of the laser welding apparatus according to the present embodiment includes a laser beam source 1, and an intermediate optical system 2, which includes a collimating lens 3, a beam-shaping optical element 4, a condensing lens 5, and an adjustment mechanism 6.

The laser beam source 1 is optically coupled to the intermediate optical system 2. The laser beam source 1 and the intermediate optical system 2 may be coupled via an optical fiber having a QD connector, or the like. In addition, the laser welding apparatus according to the present embodiment may further include, for example, a galvanometer mirror 100 as a scanning mechanism. The scanning mechanism according to the present embodiment may be replaced with, for example, a mechanism using a robot arm, and is not limited to the galvanometer mirror 100.

The collimating lens 3 is a convex lens having a focal length, and has a spherical lens, an aspherical lens, a tablet lens shape in which a plurality of lenses are combined, or the like.

The beam-shaping optical element 4 is a convex prism having a truncated cone shape and a truncated cone-shaped cross section processed into a shape suitable for a desired beam profile. In this embodiment, the cross section in the plane shown in FIG. 1 may be formed as a hexagonal contour defined by two parallel sides, two perpendicular sides, and two inclined sides, or may be formed based on a truncated cone shape optionally having a columnar portion. The beam-shaping optical element 4 according to the present embodiment is shown in FIG. 2, and has a flat surface 4a perpendicular to the central optical axis of the intermediate optical system 2 and an inclined surface 4b inclined with respect to the flat surface. More generally, the beam-shaping optical element 4 is a convex prism, which can be oriented in the manner shown in FIG. 2 or reversed so long as the optical system to be used can be adjusted accordingly with the beam-shaping optical element 4. In the embodiment, the convex surface is the front side, i.e., the side through which the optical beam enters.

The condensing lens 5 is an optical element for condensing light, including one or a plurality of lenses. For example, when the laser welding apparatus includes the galvanometer mirror 100, the condensing lens 5 may be an fθ lens.

The intermediate optical system 2 is provided between the laser beam source 1 and a processing target 7. In the intermediate optical system 2 according to the present embodiment, the collimating lens 3, the beam-shaping optical element 4, and the condensing lens 5 are disposed in this order, such that the central axes of the collimating lens 3, the beam-shaping optical element 4, and the condensing lens 5 coincide with each other. In the intermediate optical system 2, the collimating lens 3 is provided at a position where the laser beam emitted from the laser beam source 1 is first incident. The beam-shaping optical element 4 according to the present embodiment is provided at a position where the laser beam passing through the collimating lens 3 enters from the convex surface side. The convex surface side is the side of the flat surface 4a. The direction in which the beam-shaping optical element 4 is provided is not limited thereto. The condensing lens 5 is provided at a position where the laser beam passing through the collimating lens 3 is incident. The galvanometer mirror 100 may be provided between the beam-shaping optical element 4 and the condensing lens 5, for example, as a mechanism for the laser welding apparatus to perform scanning.

In addition, the collimating lens 3, the beam-shaping optical element 4, the galvanometer mirror 100, and the condensing lens 5 are attached to the intermediate optical system 2 by the adjustment mechanism 6.

For example, the processing target 7 includes a metal material mainly containing an aluminum material, a copper material, or iron. In addition, a bonding portion of the processing target 7 is disposed on a stage 8 in a butt joint shape, a stacked shape, a corner-meet shape, or the like, for example. The bonding portion of the processing target 7 is normally provided at a position that coincides with the focal point of the condensing lens 5. The material of the processing target, the shape of the bonding portion, and the disposition of the bonding portion are not limited to the above.

The laser welding apparatus may scan the laser beam in a two-dimensional direction according to the processing target. The laser welding apparatus according to the present embodiment includes the galvanometer mirror 100 as a scanning mechanism. In addition, the condensing lens 5 is referred to as a “condensing lens (fθ lens) 5” hereinafter, where the condensing lens 5 is the fθ lens. However, when the processing is performed without scanning, the processing target 7 may be irradiated with the laser beam in a stationary state. When processing is performed without scanning, the galvanometer mirror 100 is an optional configuration.

For example, the laser beam source 1 is a laser device in which a wavelength conversion element is provided in a disk-shaped individual laser that oscillates visible light having the wavelength of 515 nm. The radiation mechanism of the laser beam source 1 may have any form. The laser beam emitted from the laser beam source 1 is continuous light, and may be changed to pulsed light according to a processing application.

For example, the energy distribution of the laser beam emitted from the laser beam source 1 may have, for example, a Gaussian shape or a shape similar to a Gaussian shape. The laser beam source 1 may have a multi-mode beam function. The shape of the energy distribution of the laser beam is not limited to the above.

The collimating lens 3 converts the laser beam emitted from the point light source into a parallel laser beam via a convex lens. As a result, the laser beam emitted from the laser beam source 1 and having a divergence angle that increases as the laser beam travels can be converted into a parallel laser beam.

The condensing lens (fθ lens) 5 according to the present embodiment is a lens that converges the laser beam on the processing target 7 while the laser beam undergoes scanning. Unlike a general condensing lens, the condensing lens (fθ lens) 5 according to the present embodiment can keep the diameter of the laser beam constant when scanned and can focus to form an image on a plane. When the laser beam is not scanned, the condensing lens (fθ lens) 5 according to the present embodiment may be replaced with a general condensing lens.

FIG. 2 illustrates the beam-shaping optical element 4 according to the present embodiment in two different views. The beam-shaping optical element 4 according to the present embodiment is an optical element that can adjust a beam profile of the laser beam, like an axicon lens. As shown in the drawing, the beam-shaping optical element 4 has the flat surface 4a perpendicular to the central axis and the inclined surface 4b inclined with respect to the plane. In the beam-shaping optical element 4, a convex prism having a truncated cone-shaped cross section converts the energy distribution of the laser beam into two beams: a main beam having relatively higher intensity and a sub-beam having relatively lower intensity than the laser beam prior to incidence thereon. This is because the flat surface 4a and the inclined surface 4b contribute to converting the optical path of the parallel laser beam into two beams. The beam-shaping optical element 4 controls the energy ratio of the laser beam that is converted by the area ratio of the flat surface 4a to the inclined surface 4b.

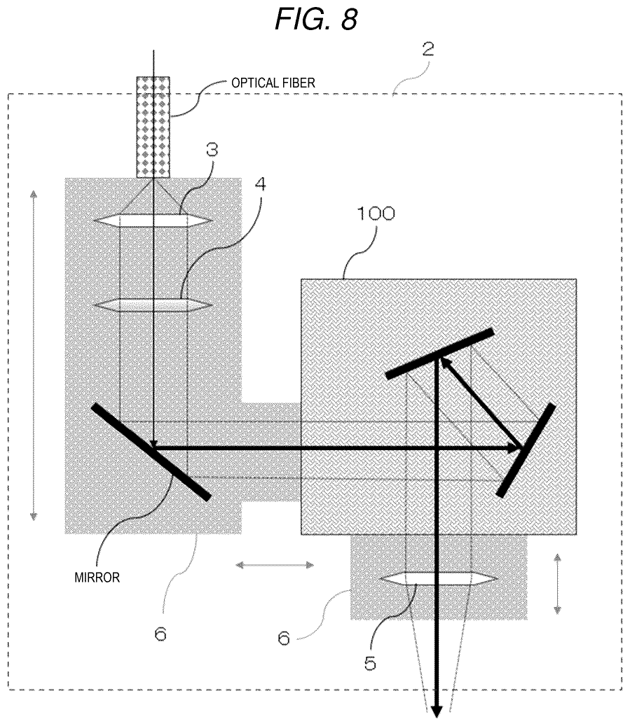

The adjustment mechanism 6 has a mechanism that changes the position of the collimating lens 3, the beam-shaping optical element 4, and the condensing lens (fθ lens) 5, so that the optical axis, the optical path, and the focal length can be adjusted. The adjustment mechanism 6 may include a mechanism such as a lens holder including a rotatable holder that can exchange each optical element with a corresponding one depending on the wavelength or a scanning speed of the laser beam. In addition, in order to adjust the depth of the processing point, for example, a driving mechanism that moves the collimating lens 3 back and forth along direction of the optical axis may be provided. FIG. 8 shows a configuration of the intermediate optical system 2 according to the embodiment. In the drawing, the supply of laser beam from the laser beam source 1 is performed via an optical fiber. As shown in the drawing, the optical path of the intermediate optical system 2 may include a control device (e.g., galvanometer mirror 100) such as a galvanometer scanner, other folding mirrors, a mask, and a filter. The folding mirror is provided in the optical path to bend the light beam, and the adjustment mechanism 6 may adjust the positions of the optical elements in accordance with the desired optical path. The adjustment mechanism 6 may have any form as long as the adjustment mechanism 6 changes the position of the collimating lens 3, the beam-shaping optical element 4, the condensing lens (fθ lens) 5, and the like, and adjusts the optical axis, the optical path, and the focal length.

The beam diameter (and also the divergence angle) of the laser beam increases as the laser beam travels further prior to incidence on the collimating lens. In addition, the beam diameter (and also the divergence angle) depends on the wavelength.

The stage 8 has a role of fixing a stage on which a processing target is provided at a position where a processing point of the processing target 7 coincides with the focal point of the fθ lens.

The laser beam emitted from the laser beam source 1 passes through the collimating lens 3 provided in the intermediate optical system 2 and is converted into a parallel laser beam. Thereafter, the parallel laser beam is incident on the side of the flat surface 4a of the beam-shaping optical element 4, and is converted into a beam shape suitable for reducing the spatter from the shape before the incidence by passing through the beam-shaping optical element 4.

In the laser beam incident on the side of the flat surface 4a of the beam-shaping optical element 4, a portion incident on the flat surface 4a is converted into a main beam, and a portion incident on the inclined surface 4b is converted into a sub-beam. The main beam is a laser beam parallel to a central axis. The optical path of the sub-beam is bent by the inclined surface 4b. The sub-beam is a laser beam that is shaped according to an inclination of the inclined surface 4b with respect to the central axis.

The main beam and the sub-beam branched into two beams pass through the condensing lens (fθ lens) 5 and are irradiated on the processing point of the processing target 7.

FIG. 3 shows an energy distribution at the focal point of the irradiation beam according to the present embodiment. The energy distribution of the laser beam at a position where the beam profile of the light source is imaged depends on the shape of the beam-shaping optical element 4. The intensity distribution of the imaged irradiation beam according to the present embodiment is formed in a double shape in which a central portion and an outer portion are divided, as shown in the drawing. A main beam having relatively high intensity is formed as a primary core beam in the central portion, and a sub-beam having relatively low intensity is formed as a secondary ring beam in the outer portion.

Here, the design of the power ratio between the primary core beam and the secondary ring beam will be described. When the beam diameter of the laser beam incident on the beam-shaping optical element 4 is defined as B, the diameter of the flat surface 4a is defined as Dp, the power of the primary core beam at the focal point is defined as Pc, and the power of the secondary ring beam at the focal point is defined as Pr, this ratio is represented by the following relational expression.

$$\frac{{P}_{r}}{{P}_{c}} = \frac{\{ B / {2}^{2} - {( {D}_{p} / 2 )}^{2} \} π}{{( {D}_{p} / 2 )}^{2} \} π} = \frac{{B}^{2} - {D}_{p}^{2}}{{D}_{p}^{2}}$$

When it is desired to calculate the desired power in the primary core beam by modifying the above expression, the power is represented by the following relational expression:

$${D}_{p} = \sqrt{\frac{{B}^{2}}{( {P}_{r} / {P}_{c} ) + 1}}$$

Therefore, the area ratio of the flat surface 4a to the inclined surface 4b in the beam-shaping optical element 4 depends on the beam diameter. The shape of the beam-shaping optical element 4 can be set from the above relational expression, and the power splitting ratio of the primary core beam to the secondary ring beam can be adjusted to a desired value.

For example, in a laser oscillator having the wavelength of 1030 nm, consider a case using a laser welding apparatus including a collimating lens 3 having a diameter of 50 mm and a focal length of 150 mm, the beam-shaping optical element 4 in which an upper base of the trapezoid is 25.6 mm, a lower base of the trapezoid is 50.1 mm, the inclination of the trapezoid's bottom or top base is 0.11°, and the height of the truncated cone is 5 mm, and a condensing lens (fθ lens) 5 having a diameter of 50 mm and a focal length of 345 mm. When the beam diameter B of the laser incident on the beam-shaping optical element 4 is set to 30 mm, and the distribution ratio of the power Pc of the primary core beam at the focal point is equivalent to the power Pr of the secondary ring beam at the focal point, the diameter Dp of the flat surface 4a is 21.2 mm.

Effects of the present embodiment will be described.

In the laser welding apparatus according to the present embodiment, the beam-shaping optical element 4, which is a single optical element adjusted to a predetermined shape, is provided in the optical system. The beam-shaping optical element 4 can convert the incident laser beam and irradiate with a two-branched double luminous flux as shown in FIG. 3. When the processing target is irradiated with the double luminous flux, the amount of heat input from the secondary ring beam is increased, unlike a normal single beam. As a result, the keyhole and the molten pool formed by the primary core beam are increased, so that the probability of interference between the metal vapor generated from the keyhole and the liquid metal in the molten pool is reduced, and the generation of the spatter is reduced. In particular, the second ring-shaped sub-beam increases the width, volume, and depth of the keyhole and the molten pool through peripheral preheating, compared with the case of using only a single core beam. On the other hand, the amount of metal vapor itself does not decrease; rather, enlarging and stabilizing the keyhole-molten-pool system lowers the probability of interference between the metal vapor and the molten metal. Consequently, pressure spikes are suppressed and spatter generation is reduced. That is, the laser beam having an energy distribution branched by the beam-shaping optical element 4 is generated, so that high-precision welding is achieved while the beam shape formed by branching reduces the generation of the spatter in the processing target 7.

In addition, in the present embodiment, for example, the position of the collimating lens 3 is moved back and forth in the central axis direction, so that the intensity of the primary core beam, the diameter of the double luminous flux, and the like can be adjusted. As a result, the size of the gap generated between the primary core beam and the secondary ring beam can be adjusted, and control such as how much the molten pool and the keyhole are formed at the processing point of the processing target is achieved. Normally, the smaller the size of the gap generated between the primary core beam and the secondary ring beam, the more the effect of reducing the spatter can be expected.

The beam-shaping optical element 4 according to the present embodiment does not require a complicated apparatus configuration or optical system preparation, unlike a laser welding apparatus that irradiates with the double luminous flux having the effect of reducing the spatter in the related art. Therefore, the spatter can be reduced in the present embodiment by simply providing a single beam-shaping optical element in the optical system of a general laser welding apparatus. The laser welding apparatus according to the present embodiment is a general-purpose mechanism that can be easily installed in the optical system of an existing laser welding apparatus and can be easily maintained.

In the present embodiment, the configuration is described in which the beam-shaping optical element 4 is provided using the disk-shaped individual laser beam source 1 that emits visible light having the wavelength of 515 nm, but the wavelength band of the laser beam used in the laser welding apparatus may be changed to an infrared band or an ultraviolet band. However, when such a change is made, it is necessary to consider a difference in refractive index depending on the wavelength. That is, in some cases, it may be necessary to exchange the attached beam-shaping optical element 4 or other lenses or the like for those in accordance with the wavelength.

In the intermediate optical system 2, each lens provided may be replaced with a Fresnel lens or the like to be thinned. In addition, in order to prevent damage to the light source due to the reflected light generated inside the optical system, for example, the flat surface 4a of the beam-shaping optical element may be disposed to be inclined slightly with respect to the optical axis. The inclination angle of the flat surface 4a with respect to the optical axis is determined by the size of the optical system, and is normally within 0.5°.

### Second Embodiment

Next, a second embodiment will be described. Features that are common to the first embodiment will not be described again. The laser device 1 of the present embodiment is obtained by replacing the beam-shaping optical element 4 provided in the intermediate optical system 2 in FIG. 1 with a beam-shaping optical element 42 that forms a triple luminous flux.

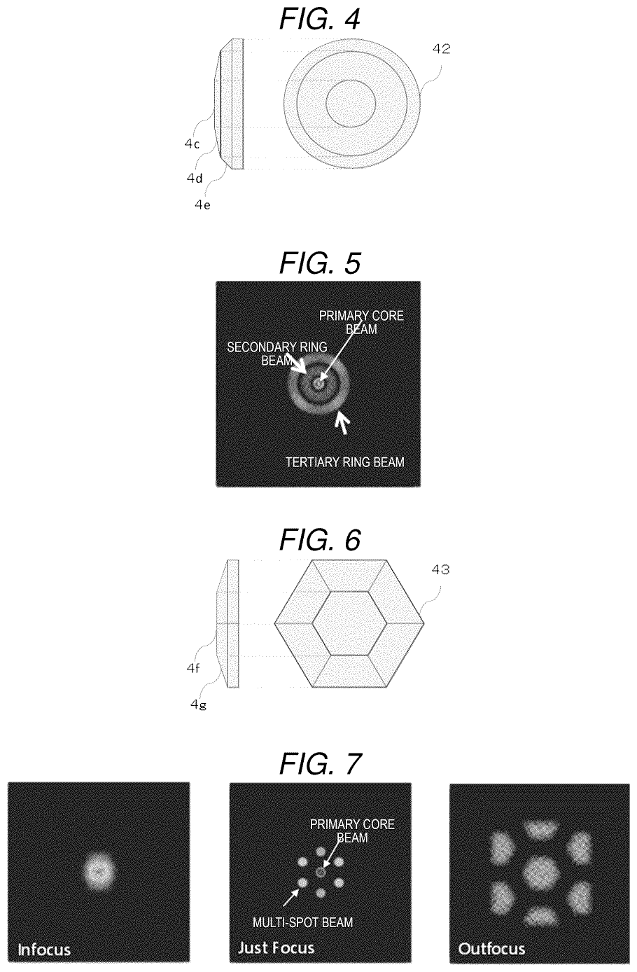

FIG. 4 illustrates a beam-shaping optical element according to the second embodiment in two different views. The beam-shaping optical element 42 according to the present embodiment is an optical element that can adjust a beam profile of the laser beam as in the first embodiment. As shown in the drawing, the beam-shaping optical element 42 has a flat surface 4c perpendicular to the central axis, a first inclined surface 4d inclined with respect to the plane, and a second inclined surface 4e further inclined with respect to the first inclined surface 4d. The beam-shaping optical element 42 may not have a focal length.

In the beam-shaping optical element 42, a convex prism having a polygonal cross section converts the incident laser beam into three beams: a main beam having high intensity, a sub-beam having relatively low intensity, and an auxiliary beam having further low intensity from the laser beam prior to incidence thereon. This is because the flat surface 4c, the first inclined surface 4d, and the second inclined surface 4e contribute to converting the parallel laser beam incident thereon along the central axis into three beams.

In the parallel laser beam incident on the side of the flat surface 4c of the beam-shaping optical element 42, a portion incident on the flat surface 4c is converted into a main beam, a portion incident on the inclined surface 4d is converted into a sub-beam, and a portion incident on the inclined surface 4e is converted into an auxiliary beam. The main beam is a laser beam parallel to a central axis. The optical path of the sub-beam is bent by the inclined surface 4d. In addition, the sub-beam is a laser beam that is shaped according to an inclination of the inclined surface 4d with respect to the central axis. The optical path of the tertiary ring beam is bent by the inclined surface 4e. The auxiliary beam is a laser beam that is shaped by an inclination of the inclined surface 4e with respect to the central axis.

The main beam, the sub-beam, and the auxiliary beam pass through the condensing lens (fθ lens) 5 and are irradiated on a processing point of the processing target 7 provided at the focal point.

FIG. 5 shows an energy distribution of the irradiation beam at the focal point according to the present embodiment. The energy distribution of the laser beam imaged at the focal point of the condensing lens 5 depends on the shape of the beam-shaping optical element 42. The intensity distribution of the imaged irradiation beam according to the present embodiment is formed as the triple luminous flux in which a central portion and an outer portion are divided, as shown in the drawing. The main beam having high intensity is formed as a primary core beam in the central portion. In the outer portion, a sub-beam having a relatively low intensity is formed as a secondary ring beam. Furthermore, the auxiliary beam having a low intensity is formed as a tertiary ring beam. As in the first embodiment, the beam-shaping optical element 42 controls the energy ratio of the laser beam that is branched by the area ratio of the flat surface 4c, the first inclined surface 4d, and the second inclined surface 4e.

Effects of the present embodiment will be described. The description of the same effects as previously described for the first embodiment is omitted.

The laser welding apparatus according to the present embodiment can irradiate with the triple luminous flux branched into three beams as shown in FIG. 5 by providing a beam-shaping optical element 43 in the intermediate optical system. When the processing target is irradiated with the triple luminous flux, a larger number of molten pool regions are formed than in the first embodiment. That is, a shallower molten pool region is further formed around the region irradiated with the secondary ring beam. Thereafter, the primary core beam generates a keyhole in the molten pool region formed by the secondary ring beam and the tertiary ring beam, so that the generation of the spatter is reduced.

In addition, also in the present embodiment, the position of the collimating lens 3 is moved back and forth in the central axis direction, so that the intensity of the primary core beam, the diameters of the secondary ring beam and the tertiary ring beam, and the like can be adjusted. As a result, the size of the gap generated between the primary core beam and the secondary ring beam and the size of the gap generated between the secondary ring beam and the tertiary ring beam can be adjusted, and control such as how much the molten pool and the keyhole are formed at the processing point of the processing target is achieved. As in the first embodiment, the smaller the size of the gap generated between the primary core beam and the secondary ring beam, the more the effect of reducing the spatter can be expected. Similarly, the smaller the size of the gap generated between the secondary ring beam and the tertiary ring beam, the more the effect of reducing the spatter can be expected.

### Third Embodiment

Next, a third embodiment will be described. Features that are common to the embodiments previously described will not be described again. A laser device of the present embodiment is obtained by changing the beam-shaping optical element 4 provided in the intermediate optical system 2 in the first embodiment to the beam-shaping optical element 43 that forms a luminous flux having a central point group shape.

FIG. 6 illustrates a beam-shaping optical element according to the third embodiment in two different views. The beam-shaping optical element 43 according to the present embodiment is an optical element having an outer shape that is of a hexagonal shape. As shown in the drawing, the beam-shaping optical element 43 has a flat surface 4f that is perpendicular to the central axis and processed into a hexagonal shape, and six inclined surfaces 4g that are connected to each other and are each inclined with respect to one side of the flat surface 4f. The beam-shaping optical element 43 may not have a focal length.

In the beam-shaping optical element 43, a single convex prism converts the laser beam into a main beam having high intensity and sub-beams having relatively low intensity from the laser beam prior to incidence thereon. The sub-beams travel along six optical paths. This is because the beam-shaping optical element 43 according to the present embodiment has six inclined surfaces 4g that are connected to each other. The flat surface 4f and the inclined surface 4g contribute to converting the parallel laser beam incident thereon into a total of seven beams including a main beam and six sub-beams.

In the parallel laser beam incident on the side of the flat surface 4f of the beam-shaping optical element 42, a portion incident on the flat surface 4f is converted into a main beam, and a portion incident on the inclined surface 4g is converted into six branches as sub-beams. The main beam is a laser beam parallel to a central axis. The optical path of the sub-beam is bent into six different optical paths by the inclined surface 4g, and each of the optical paths is a laser beam that is shaped by an inclination of the inclined surface 4g with respect to the central axis.

The main beam and the six sub-beams pass through the condensing lens (fθ lens) 5 and are irradiated on the processing point of the processing target 7 provided at the focal point of the condensing lens (fθ lens) 5.

FIG. 7 shows an energy distribution in the vicinity of the focal point of the irradiation beam according to the present embodiment. The energy distribution of the laser beam, which is irradiated on the focal point of the condensing lens (fθ lens) 5, depends on the shape of the beam-shaping optical element 43. The drawing shows, in order from the left, the following intensity distributions: in-focus, imaged at a position prior to a focal point; just-focus, imaged at the focal point; and out-of-focus, imaged at a position past the focal point. When performing the welding processing, it is ideal that the processing point of the processing target is at the position of just-focus. As shown in the intensity distribution at the just-focus, the central portion and the outer portion are divided. The main beam having high intensity is formed as a primary core beam in the central portion. In the outer portion, the sub-beams having a relatively low intensity are formed at six locations as multi-spot beams. As in the first embodiment, the beam-shaping optical element 43 controls the energy ratio of the laser beams that are converted by the area ratio between the flat surface 4f and the inclined surface 4g.

Effects of the present embodiment will be described. The description of the same effects as previously described for the first embodiment is omitted.

In the laser welding apparatus according to the present embodiment, the beam-shaping optical element 43 is provided in the intermediate optical system, so that the luminous flux having a central point group shape branched into seven beams as shown in the just-focus intensity distribution of FIG. 7, can be irradiated. When the luminous flux having a central point group shape is irradiated on the processing target, a larger number of molten pool regions are formed than in the first embodiment. That is, a shallower molten pool region is further formed around the region irradiated with the six multi-spots. Thereafter, the primary core beam generates a keyhole in the molten pool region formed by six multi-spots, so that the generation of the spatter is reduced.

In addition, also in the present embodiment, the position of the collimating lens 3 is moved back and forth in the central axis direction, so that the intensity of the primary core beam, the diameter of the luminous flux having a central point group shape, and the like can be adjusted. As a result, the size of the gap generated between the primary core beam and the multi-spot beam can be adjusted, and control how much the molten pool and the keyhole are formed at the processing point of the processing target is achieved.

In the present embodiment, the hexagonal optical element is used for the beam-shaping optical element 43 so that the number of multi-spots is six. However, the shape of the beam formed by the beam-shaping optical element may be any shape as long as the shape has an effect of reducing the generation of the spatter at the processing point and preventing the quality from being deteriorated due to the processing defect. In addition, the outer shape of the beam-shaping optical element is not limited to a hexagon, and may be a polygon or a circle. Therefore, the number and disposition of the multi-spots provided in the central point group shape beam may be appropriately changed.

While certain embodiments have been described, these embodiments have been presented by way of example only, and are not intended to limit the scope of the disclosure. Indeed, the novel embodiments described herein may be embodied in a variety of other forms; furthermore, various omissions, substitutions and changes in the form of the embodiments described herein may be made without departing from the spirit of the disclosure. The accompanying claims and their equivalents are intended to cover such forms or modifications as would fall within the scope and spirit of the disclosure.

What is claimed is:

1. A laser welding apparatus comprising:
a laser beam source configured to emit a laser beam;
a first lens configured to convert the laser beam into a parallel laser beam;
a second lens configured to focus the laser beam on a processing target; and
an optical element that is provided in an optical path between the first lens and the second lens and configured to change a beam profile of the laser beam.

2. The laser welding apparatus according to claim 1, wherein
the optical element is configured to change the beam profile of the laser beam by dividing the laser beam into a central portion and an outer portion.

3. The laser welding apparatus according to claim 1, wherein
the changed beam profile of the laser beam is composed of a double luminous flux including a primary core beam and a secondary ring beam, and the double luminous flux is formed at a focal point of the second lens.

4. The laser welding apparatus according to claim 1, wherein
the changed beam profile of the laser beam is composed of a triple luminous flux including a primary core beam, a secondary ring beam, and a tertiary ring beam, and the triple luminous flux is formed at a focal point of the second lens.

5. The laser welding apparatus according to claim 1, wherein
the changed beam profile of the laser beam is composed of a luminous flux having a central point group shape including a primary core beam and a multi-spot beam, and the luminous flux having a central point group shape is formed at a focal point of the second lens.

6. The laser welding apparatus according to claim 1, wherein
the optical element has a substantially flat surface at a center axis thereof and an inclined surface on an outer periphery of the flat surface.

7. The laser welding apparatus according to claim 6, wherein
the optical element has two or more inclined surfaces on the outer periphery of the substantially flat surface.

8. The laser welding apparatus according to claim 6, wherein
the substantially flat surface has an inclination that is 0.5° or less with respect to a plane that is perpendicular to an optical axis of the laser beam incident thereon.

9. The laser welding apparatus according to claim 1, wherein
the optical element has a polygonal truncated cone-shaped cross section.

10. The laser welding apparatus according to claim 1, wherein the optical element comprises a prism.

11. A laser welding method comprising:
emitting a laser beam;
converting the laser beam into a parallel laser beam;
converting the parallel laser beam into a main beam at a center optical axis of the parallel laser beam and at least one sub-beam separated from the main beam; and
focusing the main beam and the at least one sub-beam onto a processing target for welding.

12. The laser welding method according to claim 11, wherein the at least one sub-beam includes a ring beam that surrounds the main beam.

13. The laser welding method according to claim 11, wherein the at least one sub-beam includes a first ring beam that surrounds the main beam and a second ring beam that surrounds the first ring beam.

14. The laser welding method according to claim 11, wherein the at least one sub-beam includes six sub-beams that surround the main beam.

15. The laser welding method according to claim 11, wherein the main beam and the at least one sub-beam are converted from the parallel laser beam by an optical element having a substantially flat surface at a center axis thereof and an inclined surface on an outer periphery of the flat surface.

16. The laser welding method according to claim 15, wherein
the optical element has two or more inclined surfaces on the outer periphery of the substantially flat surface.

17. The laser welding method according to claim 15, wherein
the substantially flat surface has an inclination that is 0.5° or less with respect to a plane that is perpendicular to an optical axis of the laser beam incident thereon.

18. The laser welding method according to claim 15, wherein
the optical element has a polygonal truncated cone-shaped cross section.

19. The laser welding method according to claim 15, wherein the optical element comprises a prism.

20. The laser welding method according to claim 11, further comprising:
adjusting a location at which the laser beam is converted into the parallel laser beam.
